(19) United States
(12) Patent Application Publication
(10) Pub. No.: US 2005/0046389 A1
(43) Pub. Date: Mar. 3, 2005

(54) Method for counting cycle count of a smart battery and method and device for correcting full charge capacity of a smart battery using the same

(75) Inventor: Dong Hoon Kim, Kyonggi-do (KR)

Correspondence Address: VOLPE AND KOENIG, P.C., UNITED PLAZA, SUITE 1600, 30 SOUTH 17TH STREET, PHILADELPHIA, PA, 19103, US

(73) Assignee: MTEQ Systems Inc., Kyonggi-do (KR)

(21) Appl. No.: 10/702,891

(22) Filed: Nov. 6, 2003

(30) Foreign Application Priority Data
Nov. 8, 2002 (KR) 10-2002-0069048
Oct. 28, 2003 (KR) 10-2003-0075659

(51) Int. Cl. H02J 7/00

(52) U.S. Cl. 320/132

(57) ABSTRACT

A method for counting cycle count of a smart battery, a method and device for correcting full charge capacity of a smart battery, which is used as reference capacity for indicating correct remaining capacity of the battery, are disclosed. The present invention increase cycle count that is a standard for updating FCC in gradual floating variables in consideration of SOC to obtain continuous cycle count. FCC information is updated when the battery has been fully charged or the integer of the cycle count increases 1 using a predetermined FCC correction table in which FCC correction values varying with the cycle count are linearized by sections. This improves reliability in actually corrected FCC information and increases accuracy in the remaining capacity indicated on the basis of the FCC information.

### BACKGROUND OF THE INVENTION

1. Field of the Invention

The present invention relates to a smart battery and, more particularly, to a method for counting cycle count of a smart battery in gradual floating variables. In addition, the present invention relates to a method and device for correcting full charge capacity (FCC) of a smart battery, which is used as reference capacity for indicating accurate remaining capacity of the smart battery, using the method of counting cycle count of a smart battery.

2. Description of the Related Art

In general, a portable electronic device, such as a notebook computer, PDA, cellular phone and so on, includes a battery that displays the current remaining capacity thereof and recharging time, which is called a smart battery. The smart battery has a predetermined internal control unit to provide the current temperature, operation state and remaining capacity of the battery to an electronic device combined with the battery.

The remaining capacity of the smart battery indicates relative state of charge (RSOC) in a percentage of current full charge capacity, and the actual remaining capacity of the battery is represented in the quantity of current [mAH] corresponding to the percentage of RSOC, as well known in the art. The full charge capacity means maximum chargeable capacity of the smart battery and it decreases exponentially in inverse proportion to cycle count of the battery, as shown in FIG. 1. The graph of FIG. 1 shows a variation in full charge capacity, obtained when an operation of completely discharging a smart battery having the initial full charge capacity of 2000 mAh and then fully charging the battery is repeated. The aforementioned conventional control unit (not shown) of the smart battery updates the full charge capacity when the battery is completely discharged and then fully charged, to correct an error in the remaining capacity of the battery. However, it is rarely that a general user uses an electronic device like a notebook computer until its battery is completely discharged and then fully charges it. The general user recharges the battery before it is completely discharged or he/she applies external power to the electronic device when the capacity of the battery is 95˜100% of the full charge capacity so that the full charge capacity is barely updated.

Accordingly, the error in the remaining capacity of the battery increases as the cycle count of the battery increases. As a result, the conventional smart battery has a problem that it should warn its user of a shortage of power in advance before its practical full charge capacity is completely used in order to prevent battery power from being out while an electronic device employing the battery is being used because of incorrect indication of remaining capacity of the battery. To solve this problem, there has been proposed a method of correcting remaining capacity according to learning of FCC. The conventional FCC learning method initiates the discharging operation when the battery has been fully charged and updates FCC using capacity, which has been discharged until the battery voltage reaches the end of discharge voltage level (EDV), that is, until complete discharging is approaching, as reference capacity.

In this case, FCC is updated before the battery is completely discharged so that the conventional problem that FCC is not actually updated can be prevented. However, even with this FCC learning method, FCC is not updated when the battery is recharged before the battery voltage is decreased to the EDV. Furthermore, since the output voltage of the smart battery is abruptly reduced when complete discharging is impending, an error is generated in learnt FCC data in the case that FCC is updated using the conventional FCC learning method. Accordingly, information about accurate remaining capacity cannot be provided.

Korean Pat. Publication No. 02-41198 discloses a technique of correcting an error in the remaining capacity of a smart battery using a predetermined remaining capacity correction table in which output voltages, output currents and battery temperatures by cycle counts are stored. However, this technique corrects remaining capacity information by comparing a battery voltage measured when complete discharging of the battery is impending with a reference voltage stored in the remaining capacity correction table. Thus, it provides incorrect remaining capacity due to an error generated in the measurement of the battery voltage. In addition, the aforementioned technique sets a cycle count range of the remaining capacity correction table, which provides the same data, to a wide range of fifty cycles approximately. Thus, it cannot correct an error in the remaining capacity information, which varies according to an increase in the cycle count of the battery. Moreover, accurate cycle count cannot be counted when full charging/discharging is not impending.

### SUMMARY OF THE INVENTION

An object of the present invention is to provide a method for counting cycle count of a smart battery, which can obtain cycle count of a battery in continuous floating variables irrespective of charging state of the battery.

Another object of the present invention is to provide a method and device for correcting FCC of a smart battery, which is varied according to an increase in cycle count of the battery, in real time to improve accuracy in information about remaining capacity of the battery.

To accomplish the object of the present invention, there is provided a method for counting cycle count of a smart battery, comprising a first step of calculating accumulated battery charge capacity using a predetermined state of charge (SOC) capacity table in which battery capacities are stored corresponding to states of charge (SOC) of the battery, divided into a plurality of sections, and cycle counts of the battery; a second step of obtaining a difference between the accumulated battery charge capacity when battery charging is finished and remaining capacity of the battery when battery charging starts and calculating a ratio of the difference to current full charge capacity; and a third step of increasing the cycle count in floating variables, corresponding to the radio of the difference.

To accomplish the object of the present invention, there is also provided a method for counting cycle count of a smart battery, comprising a first step of calculating accumulated battery charge capacity using a predetermined state of charge (SOC) capacity table in which battery capacities are stored corresponding to states of charge (SOC) of the battery, divided into a plurality of sections, and cycle counts of the battery; a second step of obtaining a difference between the accumulated battery charge capacity and remaining capacity of the battery when battery charging starts at a predetermined period and calculating a ratio of the difference to current full charge capacity; and a third step of increasing the cycle count in floating variables, corresponding to the radio of the difference, until battery charging is finished.

To accomplish the other object of the present invention, there is provided a method for correcting full charge capacity of a smart battery, comprising a first step of calculating accumulated first battery charge capacity using a predetermined state of charge (SOC) capacity table in which battery capacities are stored corresponding to states of charge (SOC) of the battery, divided into a plurality of sections, and cycle counts of the battery; a second step of obtaining a difference between the first battery charge capacity when battery charging is finished and remaining capacity of the battery when battery charging starts and calculating a ratio of the difference to current full charge capacity; a third step of increasing the cycle count in floating variables, corresponding to the radio of the difference; a fourth step of calculating a first FCC correction value using a predetermined FCC correction table in which FCC correction values are recorded by sections according to the cycle count of the battery when the integer of the cycle count increases 1; a fifth step of applying a predetermined correction constant to the first FCC correction value and a second battery charge capacity RM that has been accumulated until the integer of the cycle count increases 1, excepting discharged capacity, to calculate a second FCC correction value; and a sixth step of updating full charge capacity information with the second FCC correction value.

To accomplish the other object of the present invention, there is also provided a device for correcting remaining capacity of a smart battery, comprising a battery cell for charging charges supplied from an external power supply; a sensor for sensing output voltage, output current and temperature of the battery cell; a table information storage unit including a predetermined SOC capacity table in which battery charge capacity varying with state of charge (SOC) of the battery and cycle count of the battery is recorded and a predetermined FCC correction table in which FCC correction values varying with the cycle count are linearized by sections; a data storage unit for storing parameter information used for calculating remaining capacity of the battery, such as FCC information corrected on the basis of the FCC correction table and cycle count information counted on the basis of the SOC capacity table; a program storage unit for storing a predetermined operation program that counts the cycle count, corrects FCC information, calculates the remaining capacity of the battery and detects the operation state of the battery; and a controller for counting the cycle count in floating variables using the SOC correction table, updating the FCC information using the FCC correction table in real time when the cycle count increases 1 or the battery has been fully charged, and calculating the remaining capacity of the battery using data detected by the sensor and the FCC information.

According to the above-described construction, the cycle count is increased in gradual floating variables so that continuous cycle count can be obtained. Furthermore, FCC is updated at the point of time when accumulated cycle count increases 1 or the battery has been fully charged. Thus, accuracy in FCC information and the remaining capacity based thereon can be improved.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 shows the relationship between cycle count of a general smart battery and full charge capacity of the smart battery;

FIG. 2 is a block diagram showing the construction of a device for correcting remaining capacity of a smart battery according to the present invention;

FIG. 3 shows linearized FCC values by cycle counts of a smart battery according to the present invention;

FIG. 4 is a flow chart for explaining a method for counting cycle count of a smart battery according to the present invention; and

FIG. 5 is a flow chart for explaining a method for correcting full charge capacity of a smart battery according to the present invention.

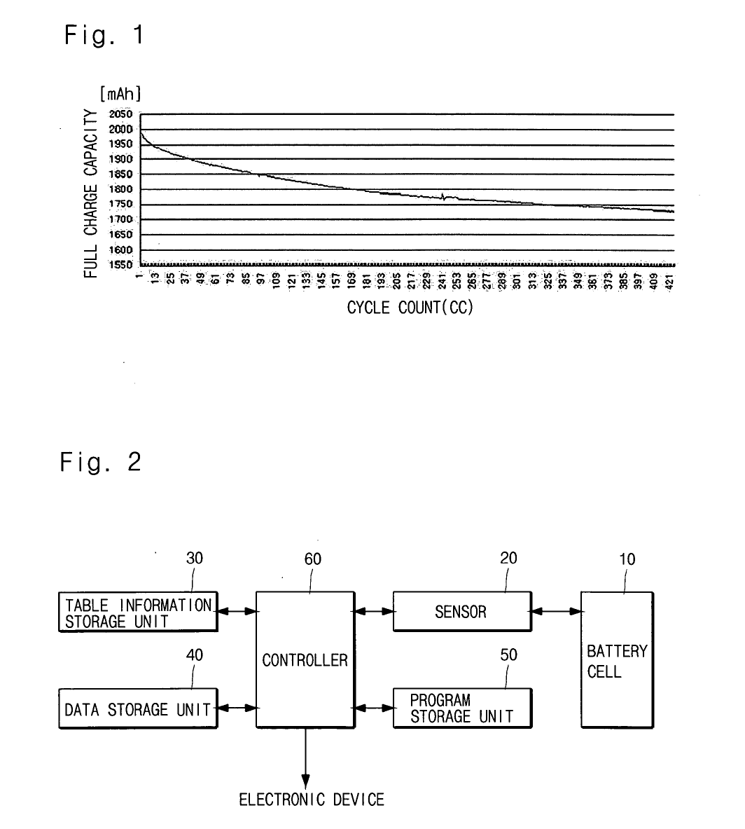

### DETAILED DESCRIPTION OF THE INVENTION

The present invention will now be described in connection with preferred embodiments with reference to the accompanying drawings.

FIG. 2 is a bock diagram showing the construction of a device for correcting remaining capacity of a smart battery according to an embodiment of the present invention, which specifically shows the configuration of a control unit set inside the smart battery.

In FIG. 2, reference numeral 10 denotes a battery cell for charging charges in the battery, 20 represents a sensor for sensing the voltage, current and temperature of the battery cell 10, and 30 indicates a table information storage unit including a predetermined state of charge (SOC) capacity table in which battery charge capacity varying with gradual SOC and cycle count of the battery is recorded and a predetermined FCC correction table in which FCC correction values varying with the cycle count are linearized by sections.

In the present invention, the state of charge (SOC) represents the remaining capacity of the battery at a percent of the current FCC. For instance, SOC 80% means that the battery is charged up to 80% of FCC thereof. The SOC capacity table is used as weight data for counting cycle count of the battery in continuous floating variables, and the FCC correction table is used as reference data for obtaining FCC correction values by cycle counts. In FIG. 2, reference numeral 40 denotes a data storage unit for storing parameter information used for calculating remaining capacity of the battery, such as FCC information corrected on the basis of the FCC correction table, information of cycle count counted on the basis of the SOC capacity table and so on.

In FIG. 2, reference numeral 50 represents a program storage unit for storing a predetermined operation program that counts the cycle count of the battery, corrects FCC information, calculates the remaining capacity of the battery and detects the operation state of the battery. Reference numeral 60 denotes a controller that calculates a difference between the remaining capacity of the battery, measured when battery charging starts, and the overall battery charge capacity accumulated until battery charging is finished using the SOC capacity table, and then obtains a ratio of the difference to current FCC to increase the cycle count of the battery in floating variables corresponding to the ratio. In addition, the controller updates the FCC information in real time using the FCC correction table in the case that the battery has been fully charged or the integer of the cycle count increases 1. Furthermore, the controller 60 calculates the remaining capacity of the battery using data detected by the sensor 20 when the battery is charged and discharged and the FCC information, and transmits information about the remaining capacity and predetermined operation state information such as temperature to an electronic device (not shown) that is electrically connected thereto.

In this embodiment, the cycle count of the battery increases in floating variables in a manner that 50.1, 50.2, 50.3, . . . , 50.9, 60.0 and 60.1. Accordingly, the FCC information is not updated in the case that the cycle count increases from 50.1 to 50.9. However, when the cycle count increases from 50.9 to 60.1 so that the integer of the cycle count increases 1 or the battery has been fully charged, the FCC information is updated. The aforementioned FCC correction operation is an embodiment of the present invention and it is possible to update the FCC information if there is a slight increase in the floating variable representing the cycle count.

Now, the SOC capacity table stored in the table information storage unit 30 is explained in more detail.

The SOC capacity table represents battery charge capacities by cycle counts, measured when the state of charge (SOC) of the battery is 100%, 75%, 50% and 25%, for example, as shown in the table 1 while the battery is fully charged and completely discharged hundreds times. The table 1 shows an example of a smart battery having battery capacity of 40 mAh. The unit of battery charge capacity is mAh.

TABLE 1

| | SOC 100% | SOC 75% | SOC 50% | SOC 25% |
|---|---|---|---|---|
| 1 count | 3917 | 2780 | 1850 | 920 |
| 50 counts | 3800 | 2558 | 1738 | 909 |
| 100 counts | 3696 | 2260 | 1604 | 847 |
| 150 counts | 3666 | 2031 | 1401 | 800 |
| 200 counts | 3529 | 1953 | 1328 | 713 |
| 250 counts | 3431 | 1634 | 1273 | 460 |

From the experiments carried out by the applicant, it can be known that there is an error of less than 5% approximately in the remaining capacity of the battery, measured according to chemical characteristics of the battery cell, between the case that the battery is fully charged when SOC is 50% and the case that it is fully charged when SOC is 0%. It can be also known that the error range varies with the cycle count of the battery. Accordingly, when an increase in the accumulated charge capacity is calculated on the basis of only the remaining capacity measured when battery charging starts, an error generates according to different states of charge. The table 1 is provided for minimizing this error.

In this embodiment, in the case that the cycle count of the battery is 70 at the point of time when battery charging starts and the remaining capacity of the battery is SOC 80%, for example, the controller 60 of FIG. 2 linearizes the section where the cycle count is 50-100 and SOC corresponds to 75˜100% using the SOC capacity table such as the table 1, to calculate an experimental remaining capacity (referred to as “SOC capacity” hereinafter) corresponding to SOC 80% and cycle count 70. Then, the controller counts battery charge capacity using the SOC capacity as a weight according to the following equation until battery charging is finished.
Second charge capacity=First charge capacity+SOC capacity [Equation 1]

Here, the first charge capacity means battery charge capacity accumulated from the point of time when battery charging starts, and the second charge capacity represents the overall battery charge capacity obtained by summing up the first charge capacity and SOC capacity.

The controller 60 of FIG. 2 increases the cycle count of the battery 0.2 in the case that a difference between the second charge capacity calculated according to Equation 1 and the remaining capacity measured when battery charging starts reaches 20% of the current FCC, for instance. The aforementioned cycle count calculation method is an example according to the present invention, and it is possible to increase the cycle count in unit of 0.1 in a floating variable whenever the difference between the second charge capacity and the remaining capacity measured when battery charging starts reaches a predetermined percent of FCC (10% of FCC, for example).

The method for counting cycle count of a smart battery according to the present invention is explained with reference to the flow chart shown in FIG. 4. The method shown in FIG. 4 is carried out through the device for correcting the remaining capacity of the smart battery, shown in FIG. 2, and the controller 60 of FIG. 2 increases the cycle count of the battery in gradual floating variables using the SOC capacity table.

First of all, when a user charges the smart battery connected with an electronic device, the battery cell 10 is charged by an external power at step ST401. At step ST402, the controller 60 of FIG. 2 records the remaining capacity of the battery, measured when battery charging starts, in the data storage unit 40. Then, it reads the current cycle count of the battery and FCC information from the data storage unit 40 and calculates a ratio of the current remaining capacity to FCC to decide SOC of the current remaining capacity. At step ST403, the controller 60 linearizes SOC capacity corresponding to the cycle count and SOC of the remaining capacity from the SOC capacity table.

At steps ST404 and ST405, the controller 60 calculates battery charge capacity (first charge capacity) accumulated from the point of time when battery charging starts until the point of time when battery charging is finished using the SOC capacity obtained at step ST403 as a weight, to obtain the overall battery charge capacity (second charge capacity), as represented in Equation 1.

At step ST406, the controller 60 of FIG. 2 obtains a difference between the second charge capacity and remaining capacity measured when battery charging starts and calculates a ratio of the difference to the current FCC. Then, the controller increases the cycle count of the battery in a floating variable, corresponding to the ratio, at step ST407. In the case that SOC is 20% when battery charging starts and SOC is 80% when charging is finished, for example, the difference as much as SOC 60% is obtained and the cycle count increases by 0.6 in a floating variable because the difference of SOC 60% corresponds to 60% of FCC.

According to the present invention, the cycle count of the battery gradually increases by the increase of the floating variable so that an increase in the cycle count can be continuously obtained even if the battery is recharged while the battery is not completely discharged.

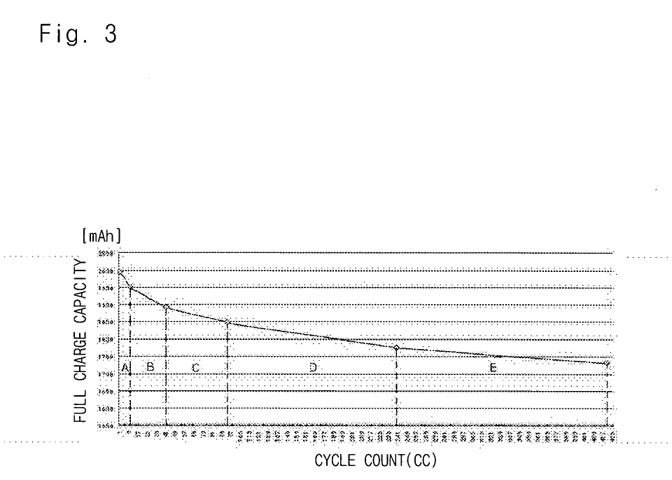

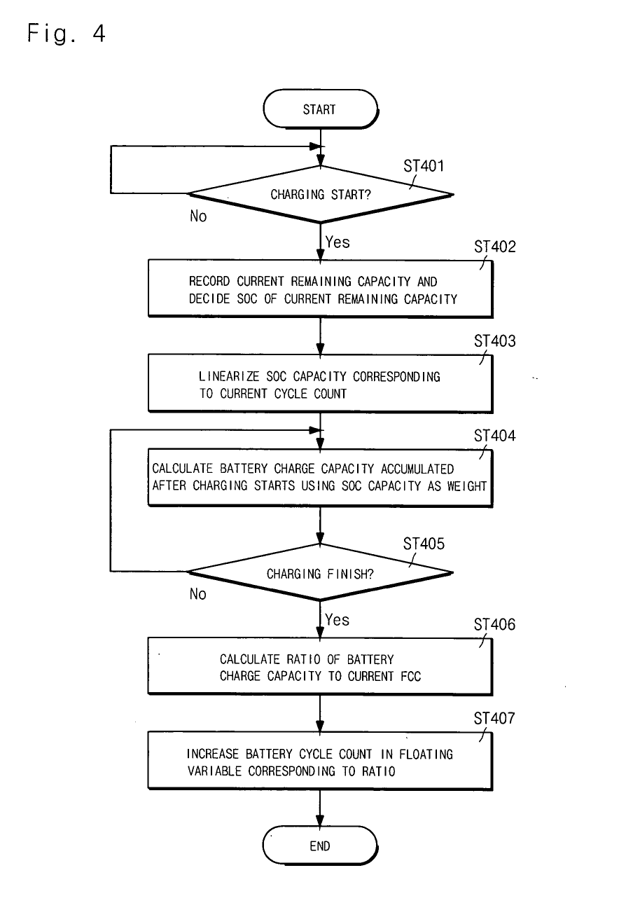

Now, the FCC correction table stored in the table information storage unit 30 of FIG. 2 is described in more detail. The FCC correction table models FCC correction value that is exponentially decreased according to an increase in the cycle count into a plurality of linearized sections (sections A to E), and then records the slope (a) and y-intercept (b) of each of the sections (A to E), as shown in the following table 2 and Equation 2. The graph of FIG. 3 linearizes FCC that actually varies when the smart battery is completely discharged and fully charged 400 times, for example. The table 2 shows an example of a smart battery having capacity of 2000 mAh. The unit of y-intercept (b) is mAh.
FCC₁=a×n+b (n: cycle count, FCC₁: first FCC₁ correction value, a: slope, b: y-intercept) [Equation 2]

In Equation 2, the first FCC correction value FCC₁ means FCC correction value calculated corresponding to cycle count n according to the FCC correction table. In the case that the cycle count is 200, for example, the first FCC correction value belongs to the section D of the table 2 (referring to FIG. 3) so that the first FCC correction value is equal to −0.633×200+1907=1780.4 [mAh].

TABLE 2

| | A | B | C | D | E |
|---|---|---|---|---|---|
| Slope (a) | −4.965 | −1.645 | −1.000 | −0.633 | −0.365 |
| y-intercept | 1993 | 1966 | 1940 | 1907 | 1861 |
| (b) | | | | | |

The controller 60 of FIG. 2 counts the cycle count of the battery in floating variables and updates FCC whenever the integer of the cycle count of the battery increases 1 or the battery has been fully charged.

Specifically, the controller 60 applies Equation 2 to the FCC correction table to obtain the first FCC correction value corresponding to the cycle count of the battery. Then, the controller 60 applies the following equation 3 to the battery charge capacity accumulated when the integer of the cycle count increases 1 or the battery has been fully charged (referred to as “point of time of updating FCC” hereinafter) and the first FCC correction value to calculate the second FCC correction value, and updates the FCC information with the second FCC correction value.

In this embodiment, the battery charge capacity accumulated when the integer of the cycle count of the battery increases 1 does not mean the actual remaining capacity of the battery at that time but only the battery charge capacity accumulated when the battery is charged, excepting charge capacity consumed when the battery is discharged. For instance, in the case that the battery is charged so much that the cycle count increases from 70 to 70.7, discharged as much as 20% of FCC, and then charged again as much as the cycle count 0.3, the actual battery charge capacity becomes 80% of FCC due to effect of discharging although the cycle count increases to 71. Thus, it is difficult to use the battery charge capacity, accumulated when the integer of the cycle count of the battery increases 1, as reference data for updating FCC. Therefore, the controller 60 shown in FIG. 2 is constructed in such a manner that it counts the battery charge capacity, excepting charge capacity consumed when the battery is discharged, from SOC 0% to SOC 100% whenever the cycle count increases 1.
FCC₂=W×RM+(1−W)×FCC₁ [Equation 3]
FCC₁: first FCC correction value, FCC₂: second FCC correction value,
RM: battery charge capacity accumulated at the point of time when FCC is updated
W, 1-W: correction constant (0<W<1)

The correction constant W in the equation 3 is selected to be an appropriate value according to the characteristic of the smart battery control unit shown in FIG. 2. According to experiments carried out by the applicant, the correction constant W is mainly affected by the characteristic of the control unit while the correction constant 1−W is under the influence of the characteristic of the battery cell 10. In general cases, it is preferable to set W to 0.5, for example.

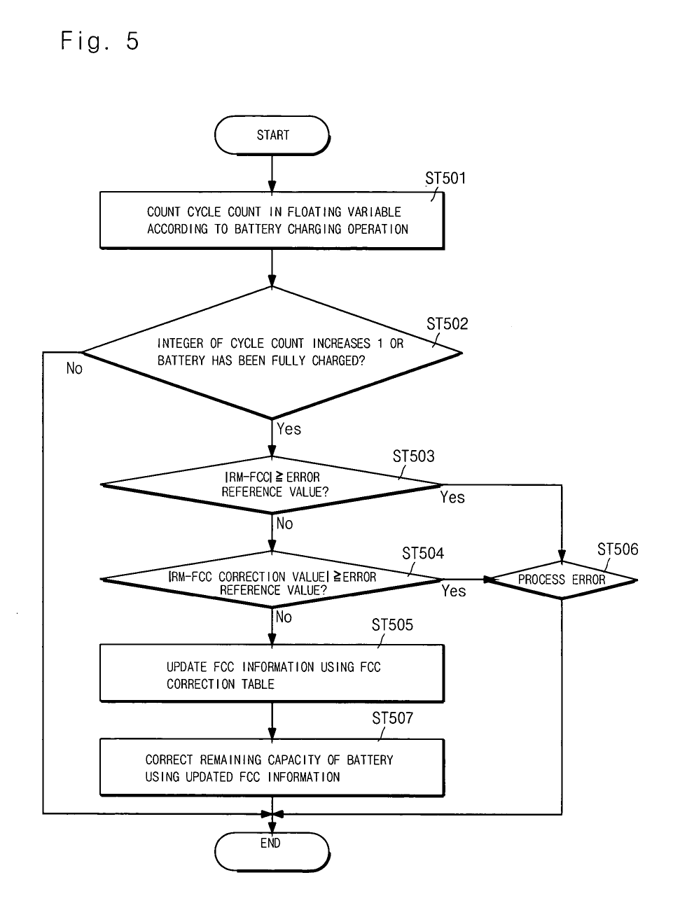

A method for correcting FCC of the smart battery according to an embodiment of the present invention is explained with reference to the flow chart of FIG. 5.

First of all, the controller 60 of FIG. 2 counts the cycle count of the battery in a floating variable according to the steps described in FIG. 4, at step ST501. In the case that the integer of the cycle count increases 1 or the battery has been fully charged, the controller 60 detects it at step ST502, to obtain a difference between the battery charge capacity RM accumulated when FCC is updated and current FCC. When the difference is less than a predetermined error reference value, the controller calculates a difference between the battery charge capacity RM and the first FCC correction value according to the aforementioned FCC correction table to confirm whether or not the difference is less than the predetermined error reference value, at steps ST503 and ST504. According to experiments carried out by the applicant, it is preferable to set the error reference value to 100˜200 mA. The steps ST503 and ST504 can be selectively executed.

In this embodiment, the battery charge capacity RM accumulated at the point of time of updating FCC is similar to the actual full charge capacity of the battery so that the controller 60 judges that the battery has been normally charged in the case that both of the difference between FCC and RM and the difference between RM and FCC correction value are less than the predetermined error reference value and updates current FCC information with the second FCC correction value calculated using the FCC correction table and Equation 3, at step ST505.

When it is judged that the difference between RM and FCC or difference between RM and FCC correction value is more than the predetermined error reference value at stepsST503 and ST504, the controller 60 does not update the current FCC information but performs a predetermined error processing operation at step ST506. In the case that the FCC information is updated according to step ST505, the controller 60 corrects battery remaining capacity stored in the data storage unit 40 on the basis of the updated FCC information, at step ST507.

Moreover, the controller 60 corrects an error in the battery remaining capacity, which varies according to repetition of recharging, on the basis of newly corrected FCC information whenever the integer of the cycle count of the battery increases 1 or general full charging is carried out, which is not shown in FIG. 5.

As described above, the present invention increases the cycle count that becomes a standard for updating FCC in gradual floating variables in consideration of SOC of the battery so that continuous cycle counts can be obtained. Furthermore, the present invention updates FCC at the point of time when the cycle count increase so that reliability in actually corrected FCC information can be improved and accuracy in remaining capacity of the battery, indicated on the basis of the FCC information, can be increased.

Although specific embodiments including the preferred embodiment have been illustrated and described, it will be obvious to those skilled in the art that various modifications may be made without departing from the spirit and scope of the present invention, which is intended to be limited solely by the appended claims.

1. A method for counting cycle count of a smart battery, comprising:
a first step of calculating accumulated battery charge capacity using a predetermined state of charge (SOC) capacity table in which battery capacities are stored corresponding to states of charge (SOC) of the battery, divided into a plurality of sections, and cycle counts of the battery;
a second step of obtaining a difference between the accumulated battery charge capacity when battery charging is finished and remaining capacity of the battery when battery charging starts and calculating a ratio of the difference to current full charge capacity; and
a third step of increasing the cycle count in floating variables, corresponding to the radio of the difference.

2. The method for counting cycle count of a smart battery, as claimed in claim 1, wherein the first step comprises the steps of:
calculating the remaining capacity of the battery when battery charging starts at a percentage of the full charge capacity, to decide the SOC of the battery;
linearizing a predetermined SOC capacity that is battery capacity corresponding to the SOC and cycle count from the SOC capacity table; and
summing up the SOC capacity and capacity charged from the point of time when battery charging starts, to calculate the battery charge capacity.

3. A method for counting cycle count of a smart battery, comprising:
a first step of calculating accumulated battery charge capacity using a predetermined state of charge (SOC) capacity table in which battery capacities are stored corresponding to states of charge (SOC) of the battery, divided into a plurality of sections, and cycle counts of the battery;
a second step of obtaining a difference between the accumulated battery charge capacity and remaining capacity of the battery when battery charging starts at a predetermined period and calculating a ratio of the difference to current full charge capacity; and
a third step of increasing the cycle count in floating variables, corresponding to the radio of the difference, until battery charging is finished.

4. A method for correcting full charge capacity of a smart battery, comprising:
a first step of calculating accumulated first battery charge capacity using a predetermined state of charge (SOC) capacity table in which battery capacities are stored corresponding to states of charge (SOC) of the battery, divided into a plurality of sections, and cycle counts of the battery;
a second step of obtaining a difference between the first battery charge capacity when battery charging is finished and remaining capacity of the battery when battery charging starts and calculating a ratio of the difference to current full charge capacity;
a third step of increasing the cycle count in floating variables, corresponding to the radio of the difference;
a fourth step of calculating a first FCC correction value using a predetermined FCC correction table in which FCC correction values are recorded by sections according to the cycle count of the battery when the integer of the cycle count increases 1;
a fifth step of applying a predetermined correction constant to the first FCC correction value and a second battery charge capacity RM that has been accumulated until the integer of the cycle count increases 1, excepting discharged capacity, to calculate a second FCC correction value; and
a sixth step of updating full charge capacity information with the second FCC correction value.

5. The method for correcting full charge capacity a smart battery, as claimed in claim 4, wherein the steps following the fourth step are carried out when the smart battery has been fully charged.

6. The method for correcting full charge capacity a smart battery, as claimed in claim 4, wherein the second FCC correction value is calculated according to the equation, FCC₂=W×RM+(1−W)×FCC₁ (0<W<1), when the first and second FCC correction values are FCC₁ and FCC₂, respectively, the correction constant multiplied by the second battery charge capacity RM is W, and the correction constant multiplied by the first FCC correction value is 1−W in the fifth step.

7. The method for correcting FCC of a smart battery, as claimed in claim 4, further comprising an error processing step between the fourth and fifth steps, the error processing step obtaining a difference between the second battery charge capacity RM and current FCC, maintaining the current FCC as the FCC information when the difference exceeds a predetermined error reference value, and executing the steps following the fifth step when the difference is lower than the error reference value.

8. The method for correcting FCC of a smart battery, as claimed in claim 4, further comprising an error processing step between the fourth and fifth steps, the error processing step obtaining a difference between the second battery charge capacity RM and the first FCC correction value, maintaining the current FCC as the FCC information when the difference exceeds a predetermined error reference value, and executing the steps after the fifth step when the difference is lower than the error reference value.

9. A device for correcting remaining capacity of a smart battery, comprising:
a battery cell for charging charges supplied from an external power supply;
a sensor for sensing voltage, current and temperature of the battery cell;
a table information storage unit including a predetermined SOC capacity table in which battery charge capacity varying with state of charge (SOC) of the battery and cycle count of the battery is recorded and a predetermined FCC correction table in which FCC correction values varying with the cycle count are linearized by sections;
a data storage unit for storing parameter information used for calculating remaining capacity of the battery, such as FCC information corrected on the basis of the FCC correction table and cycle count information counted on the basis of the SOC capacity table;
a program storage unit for storing a predetermined operation program that counts the cycle count, corrects FCC information, calculates the remaining capacity of the battery and detects the operation state of the battery; and
a controller for counting the cycle count in floating variables using the SOC correction table, updating the FCC information using the FCC correction table in real time when the cycle count increases 1 or the battery has been fully charged, and calculating the remaining capacity of the battery using data detected by the sensor and the FCC information.
